(19) United States
(12) Patent Application Publication
(10) Pub. No.: US 2012/0182234 A1
(43) Pub. Date: Jul. 19, 2012

(54) ELECTRONIC DEVICE AND CONTROL METHOD THEREOF

(75) Inventors: Yu-Chen HUANG, Taipei City (TW); Chia-Yi Wu, Taipei (TW)

(73) Assignee: Quanta Computer Inc., Tao Yuan Shien (TW)

(21) Appl. No.: 13/240,590

(22) Filed: Sep. 22, 2011

(30) Foreign Application Priority Data
Jan. 18, 2011 (TW) 100101839

(51) Int. Cl. G06F 3/041

(52) U.S. Cl. 345/173

(57) ABSTRACT

An electronic device and a control method are provided. The electronic device includes a display panel, a touch panel, and a process module. The display panel displays a movable object and an indication object. The movable object is displayed on a first display region of the display panel which corresponds to a first predetermined region of the touch panel, and the indication object is displayed on a second display region of the display panel which corresponds to a second predefined region of the touch panel. When the first predefined region is touched, the processor module detects whether a drag displacement on the touch panel reaches a predefined displacement, so as to determine whether the movable object is dragged to the second predefined region. When the drag displacement is detected as reaching the predefined displacement, the processor module initiates a corresponding function of the indication object.

This application claims the benefit of Taiwan application Serial No. 100101839, filed Jan. 18, 2011, the subject matter of which is incorporated herein by reference.

### TECHNICAL FIELD

The disclosure relates in general to an electronic device and a control method thereof, and more particularly to an electronic device using a touch panel and a control method thereof.

### BACKGROUND

With the blooming development of technique made in touch sensing, there is an increasing number of electronic devices using a touch sensitive screen for displaying various patterns and texts, thereby realizing a graphical user interface for the interaction between electronic devices and users. The graphical user interface usually includes a software input panel or virtual keyboard, software or virtual keys, menus, or other graphical objects. With the graphical user interface, the electronic devices are able to recognize user's one or more fingers touching on its screen, and to initiate a corresponding application or function in response.

For example, when receiving an incoming call, an electronic device can communicate with its user by controlling a touch sensitive screen to display software keys. The software keys can be labeled with texts such as “accept” or “reject”, directing a user to operate this electronic device. At this time, when he software key of “accept” is selected, the electronic device will accept the incoming call and initiate the corresponding telephone call function of that software key. Besides, the user can also initiate the telephone call function by pressing physical keys of the electronic device. However, there is a major difference in operation between the software key and the physical key. Unlike a physical key, a key on the software keyboard, when being pressed, has difficulty in providing a user with intense feeling of a feedback from the touch of his/her fingertips. In view of such a difference, touching a software keypad to initiate a corresponding function of an electronic device makes it difficult for the user to determine whether or not a key has been correctly pressed, or how many times a key is pressed. Thus, user convenience is decreased.

Moreover, with the advance of technology, people pursue not only a practical method of operating electronic devices, but also one that is rich in creativity, novelty, or entertainment. Therefore, as regards the interaction between users and electronic devices, it is a subject in the industry to provide a graphical user interface which is convenient, human-friendly, meets user's requirements.

### BRIEF SUMMARY

Example embodiments are disclosed for an electronic device and a control method, in which the convenience of operating the electronic device can be increased. Moreover, the electronic device can provide a graphical user interface which is convenient and human-friendly, which increases user experience.

The disclosure provides an electronic device. The electronic device includes a display panel, a touch panel, and a process module. The display panel displays a movable object and an indication object. The movable object is displayed on a first display region of the display panel which corresponds to a first predetermined region of the touch panel, and the indication object is displayed on a second display region of the display panel which corresponds to a second predefined region of the touch panel. When the first predefined region is touched, the processor module detects whether a drag displacement on the touch panel reaches a predefined displacement, so as to determine whether the movable object is dragged to the second predefined region. When the drag displacement is detected as reaching the predefined displacement, the processor module initiates a corresponding function of the indication object.

The disclosure further provides a control method. The control method is for use in an electronic device, and comprises a number of steps. A movable object is displayed on a display panel, the movable object being displayed on a first display region of the display panel which corresponds to a first predetermined region of a touch panel covered on the display panel. An indication object is displayed on the display panel, the indication object being displayed on a second display region of the display panel which corresponds to a second predefined region of the touch panel. When the first predefined region is touched, it is detected whether a drag displacement on the touch panel reaches a predefined displacement, so as to determine whether the movable object is dragged to the second predefined region. When the drag displacement is detected as reaching the predefined displacement, a corresponding function of the indication object is initiated.

It is to be understood that both the foregoing general description and the following detailed description are exemplary and explanatory only and are not restrictive of the disclosed examples, as claimed.

### BRIEF DESCRIPTION OF THE DRAWINGS

FIG. 1 is a block diagram showing an electronic device according to an example of the disclosure.

FIG. 2 is a flow chart showing a control method for use in an electronic device according to an embodiment of the disclosure.

FIG. 3 is a schematic diagram showing an example of a graphical user interface displayed by an electronic device according to an embodiment of the disclosure.

FIGS. 4A and 4B are schematic diagrams each showing an example of a graphical user interface of an electronic device according to an embodiment of the disclosure, wherein a corresponding function of the indication object is not initiated in FIG. 4A and is initiated in FIG. 4B.

FIGS. 5A, 5B, 5C, and 5D are schematic diagrams each showing an example of a graphical user interface of an electronic device during the electronic device executes a control method according to an embodiment of the disclosure.

FIGS. 6A, 6B, 6C, and 6D are schematic diagrams each showing an example of a graphical user interface of an electronic device during the electronic device executes a control method according to an embodiment of the disclosure.

FIGS. 7A and 7B are schematic diagrams each showing an example of a graphical user interface of an electronic device according to an embodiment of the disclosure.

FIG. 8 is a schematic diagram showing another example of a graphical user interface of an electronic device according to an embodiment of the disclosure.

FIG. 9 is a schematic diagram showing another example of a graphical user interface of an electronic device according to an embodiment of the disclosure, wherein the electronic device includes two display panels and two touch panels.

### DETAILED DESCRIPTION OF THE DISCLOSURE

Reference will now be made in detail to examples of the present disclosure. In some embodiments, an electronic device and a control method are disclosed to provide a graphical user interface for operating the electronic device. The graphical user interface includes a movable object and an indication object which are separated by a distance. When the location of the movable object is touched, the electronic device determines whether the movable object is dragged to a region of the indication object, so as to determine whether a corresponding function of the indication object is to be initiated. As such, the sense of touching a software keypad can be improved, and the convenience of operating the electronic device can be increased. Moreover, the provided graphical user interface is convenient and human-friendly, which increases user experience.

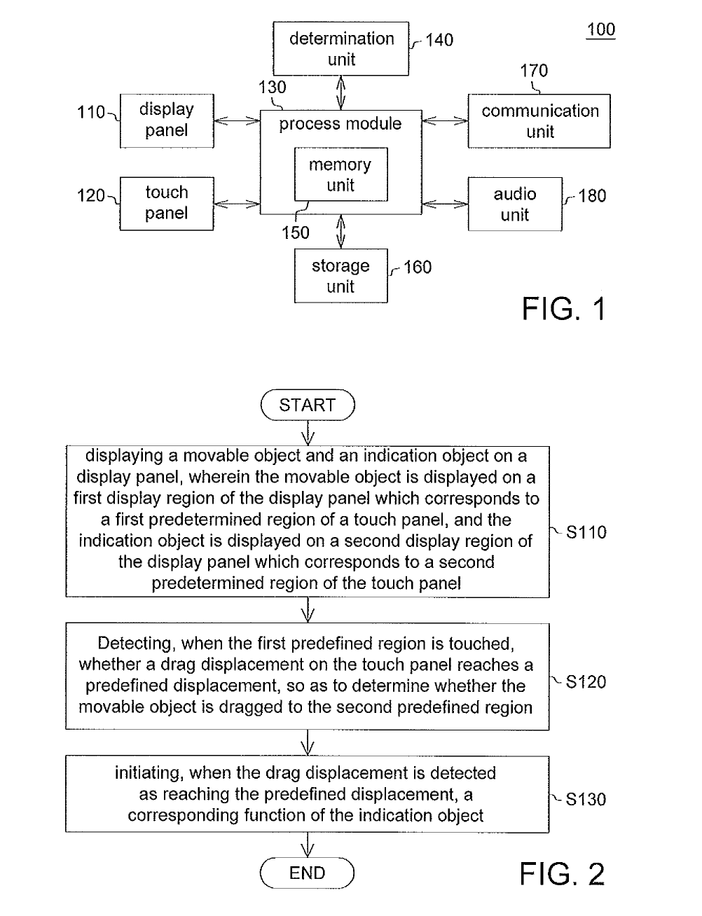

FIG. 1 is a block diagram showing an electronic device according to an example of the disclosure. In some embodiments, the electronic device 100 includes a display panel 110, a touch panel 120, and a process module 130. The display panel 110 is configured to display various kinds of information. The touch panel 120 can be one of various kinds of touch panel in terms of its sensing means or mechanism, such as resistive, capacitive, optical, surface acoustic wave (SAW) type touch panels. The touch panel 120 can be covered on the display panel 110 or integrated therein such that a display region corresponds to a touch region. The process module 130 is configured to perform or execute various kinds of threads or procedures. The process module 130 is for example implemented by a micro-processor chip, or other processor capable of performing arithmetic operations or computations. The process module 130 is configured to control the touch panel 120 to receive or detect touch input, and control the display panel 110 to display information accordingly. In other words, a graphical user interface can be provided for the interaction between the electronic device 100 and users.

In other embodiments, the electronic device 100 can further include a determination unit 140, a memory unit 150, a storage unit 160, a communication unit 170, and an audio unit 180. The determination unit 140 is configured to determine whether a drag displacement on the touch panel 120 reaches a predefined displacement. The determination unit 140 is implemented by using firmware or hardware circuits, or by an integrated chip in accordance with software codes. The memory unit 150 and the storage unit 160 are configured to store various kinds of information. The memory unit 150 can be a build-in or an external memory of the process module 130, such as a random access memory, register, cache memory, or other volatile memorial elements. The memory unit 150 can be used to store threading of various kinds of function or application that can be executed or installed on the electronic device 100. The storage unit 160 is for example a non-violate memory, such as hard discs or memory cards. The communication unit 170 is configured to transmit or receive audio, text, or video content. The communication unit 170 is, for example, a combination of antennas and radio frequency (RF) chips, in which case the electronic device 100 can be realized as a mobile phone. The audio unit 180 is configured to drive audio elements such as speakers or microphones.

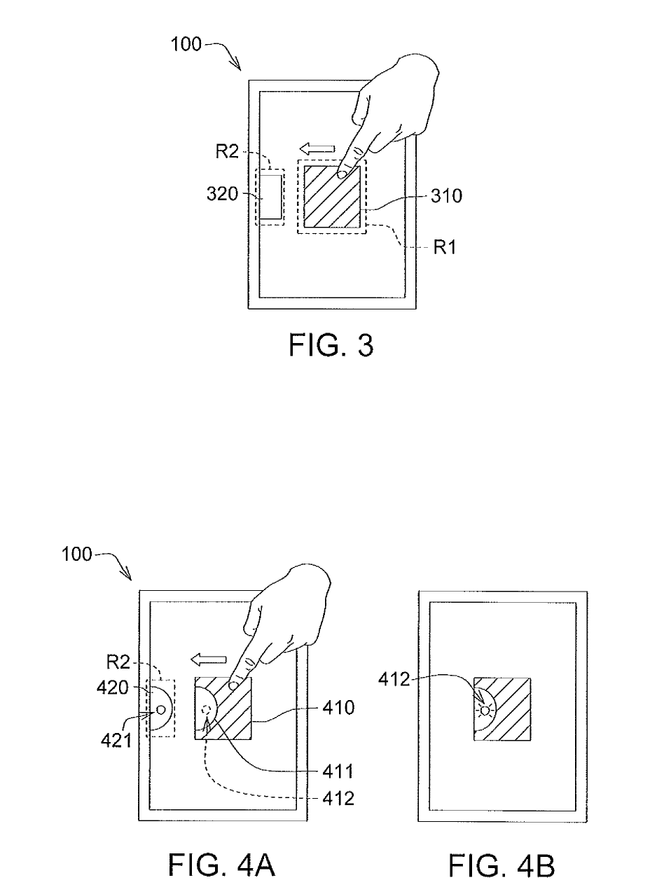

FIG. 2 is a flow chart showing a control method for use in an electronic device according to an embodiment of the disclosure. FIG. 3 is a schematic diagram showing an example of a graphical user interface displayed by an electronic device according to an embodiment of the disclosure. The control method in FIG. 2 includes a number of steps, which will be illustrated as follows with reference to FIGS. 1 and 3.

In step S110, the processor module 130 displays a movable object 310 and an indication object 320 on the display panel 110. The movable object 310 is displayed on a first display region of the display panel 110 which corresponds to a first predetermined region of the touch panel 120, such as region R1. The indication object 320 is displayed on a second display region of the display panel 110 which corresponds to a second predetermined region of the touch panel 120, such as region R2. The regions R1 and R2 are not overlapped with each other. The regions R1 and R2 are for example separated by a distance. After proper calibration, a predetermined region of the touch panel 120 can be regarded as one having substantially the same size or range as a display region of the display panel 110.

In step S120, when the first predefined region R1 is touched, the process module 130 detects whether a drag displacement on the touch panel 120 reaches a predefined displacement, so as to determine whether the movable object 310 is dragged to the second predefined region R2. As regards the drag displacement and the predetermined displacement, the drag displacement can be for example a distance between an initial touch position and a terminal touch position on the touch panel 120, while the predetermined displacement can be configured as a displacement between the first predetermined region R1 and the second predetermined region R2. In other words, in a case that a user uses his/her finger or stylus to make a touch or contact with the touch panel 120 as to grabbing the movable object 310 and starting to dragging it to a different position, the drag displacement can represent a linear distance or travel distance of the movable object 310 from its initial position. In an embodiment, the process module 140 transmits the detected drag displacement to the determination unit 140, and the determination unit 140 will determine whether the drag displacement reaches the predetermined displacement.

In step S130, when the drag displacement is detected as reaching the predefined displacement, the process module 130 initiates a corresponding function of the indication object 320. In other embodiments, when the drag displacement is detected as not reaching the predefined displacement, the process module 130 returns the movable object to its initial position, such as a position within the region R1.

FIG. 4A is a schematic diagram showing an example of a graphical user interface of an electronic device according to an embodiment of the disclosure, wherein a corresponding function of the indication object is not initiated. In this example, an indication object 420 and a movable object 410 have matched appearances. For example, in the graphical user interface of FIG. 4A, the indication object 420 and the movable object 410 have puzzle-like appearances and match with each other. The displaying of such a graphical user interface implicitly suggests or hints at a way of interaction between users and the electronic device 100. In other words, from FIG. 4A, the movable object 410 has a portion 411 whose appearance is exemplified as a missing piece (not shown by slashed lines), while the indication object 420 has its appearance shaped as one that can fill in or make up the missing piece. This suggests users for fitting together two objects 410 and 420 by dragging the movable object 410 to where the indication object 420 locates.

As shown n FIG. 4A, the indication object 420 can have a symbol 421. The symbol 421 can be for example a text, an icon, or other makers or labels. The symbol 421 is configured to identify a corresponding function of the indication object 420, so as to explicitly indicate which function will be generated when the movable object 410 and the indication object 420 are fitting together. Moreover, the movable object 410 can have a symbol 412. Being similar to the symbol 421, the symbol 412 of the movable object 410 is configured to identify the corresponding function of the indication object 420. Their difference between symbols 412 and 421 is that the symbol 412 of the movable objects 410 at this situation is hidden, or vague, which represents that the identified function of the symbol 412 has not been initiated.

FIG. 4B is a schematic diagram showing an example of a graphical user interface of an electronic device according to an embodiment of the disclosure, wherein the corresponding function of the indication object is initiated. In this example, when the corresponding function of the indication object 420 is initiated, a change in appearance of the symbol 412 of the movable object 410 is provided. From FIGS. 4A and 4B, the symbol 412 is changed from being shown by dashed lines to being shown by solid lines and several radiation lines, indicating that a change in brightness level of the symbol 412 is provided. In other embodiments, the symbol 412, gradually or directly, appears and changes to having an increasing clarity, a distinguishable color, a flash light, or any indication that obviously indicates the electronic device 100 has initiated the corresponding function of the indication object 420. In practical examples, the change in appearance of the symbol includes a change in at least one of a color, a brightness level, a size, and a clarity level of the symbol.

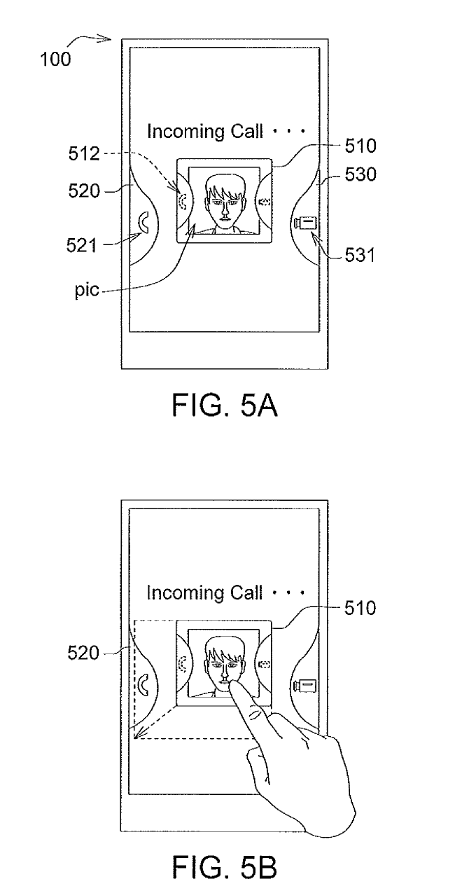

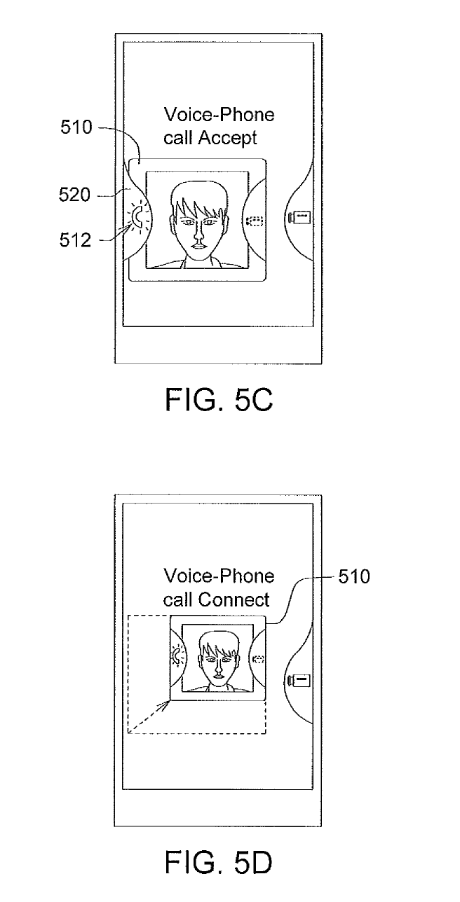

FIGS. 5A, 5B, 5C, and 5D are schematic diagrams each showing an example of a graphical user interface of an electronic device during the electronic device executes a control method according to an embodiment of the disclosure. In this example, the graphical user interface includes a movable object 510 and two indication objects 520 and 530. The displaying of the two indication objects 520 and 530 indicates there are two different functions the electronic device 100 can initiate. In this example, the corresponding functions of the two indication objects 520 and 530 are exemplified as a voice-phone call function and a video-phone call function.

As shown in FIG. 5A, the electronic device 100 receives an incoming call, and a caller's picture Pic or other information can be shown on the movable objet 100. The indication object 520 has a symbol which is exemplified as a voice-phone icon symbol 521 for identifying a voice-phone call function of the electronic device 100. The movable object 510 has a hidden or vague symbol, such as a voice-phone icon symbol 512 shown in dashed lines. As shown in FIG. 5B, the appearances of the movable object 510 and the indication object 520 suggest users for dragging the movable object 510 towards a left direction. When a user intends to drag the movable object 510 and touches a region of where the movable object 510 locates, the electronic device 100 detects a drag displacement to determine whether the movable object 510 is dragged to a region of where the indication object 520 locates. In this example, the movable object 510 has a display size which is changed in accordance with the drag displacement, which is shown by a dashed region and arrow. As shown in FIG. 5C, when the movable object 510 is dragged as reaching the region of the indication object 520, the electronic device 100 will accept the incoming call, initiate the voice-phone call function, and provide a change in appearance of the voice-phone icon symbol 512, indicating that the voice-phone call function has been initiated. As shown in FIG. 5D, after the voice-phone call function is initiated, the movable object 510 returns to its initial position.

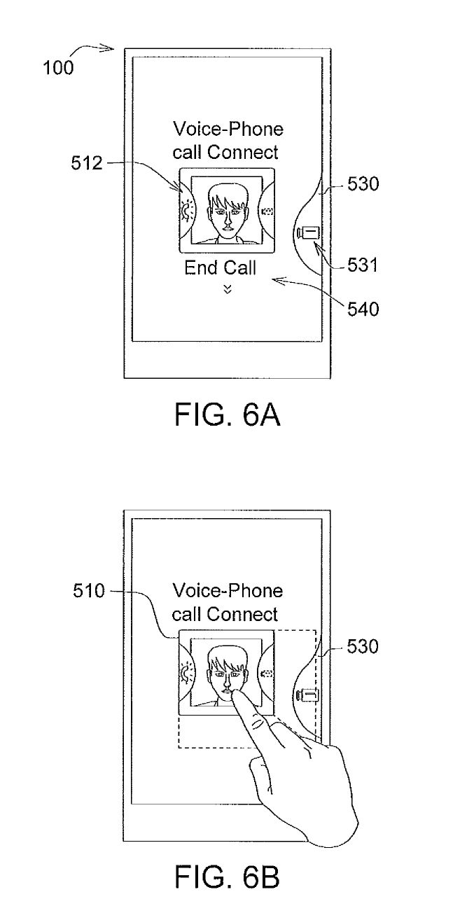

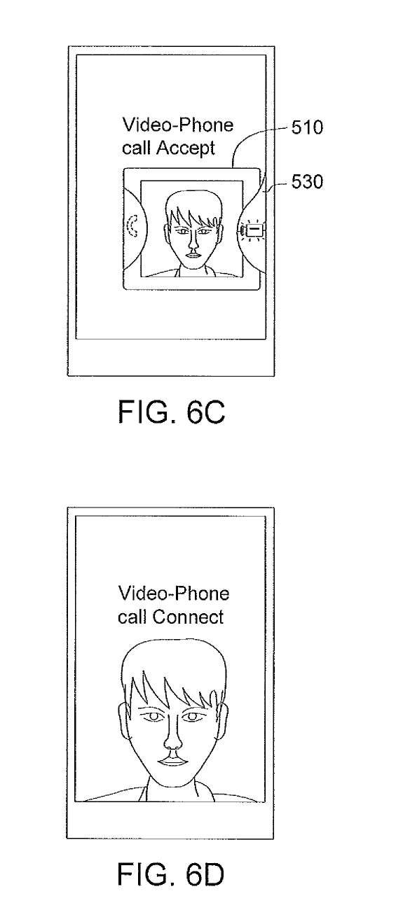

FIGS. 6A, 6B, 6C, and 6D are schematic diagrams each showing an example of a graphical user interface of an electronic device during the electronic device executes a control method according to an embodiment of the disclosure. In this example, as shown in FIG. 6A, the electronic device 100 follows that in FIG. 5D and is still in the voice-phone call state. In the graphical user interface, the indication object 530 remains displayed and can be operated by users for operating the electronic device 100. The indication object 530 has a symbol which is exemplified as a video-phone icon symbol 531 for identifying a video-phone call function of the electronic device 100. As shown in FIG. 6B, the appearances of the movable object 510 and the indication object 530 suggest users for dragging the movable object 510 towards a right direction. As shown in FIG. 6C, when the movable object 510 is dragged as reaching the region of the indication object 530, the electronic device 100 will accept and initiate the voice-phone call function. As shown in FIG. 6D, the electronic device 100 provides video frames in full screen. Alternatively, the electronic device 100 provides video frames within the region the movable object 510.

Refer to FIG. 6A for further illustration. Where the electronic device 100 is in the voice-phone call state, the graphical user interface can further include another indication object 540. The indication object 540 has a symbol such as a text of “End the call”, or a double arrow sign “ [symbol] ”. As is indicated by the arrow sign and the corresponding text, the indication object 540 suggests users for dragging the movable object 510 towards a bottom direction and initiating an end function for the phone call. As is similar to that of aforementioned embodiments, the electronic device 100 can depend on a drag displacement for determining whether the movable object 510 is dragged to the region of the indication object 540. If yes, the electronic device 100 will end the call.

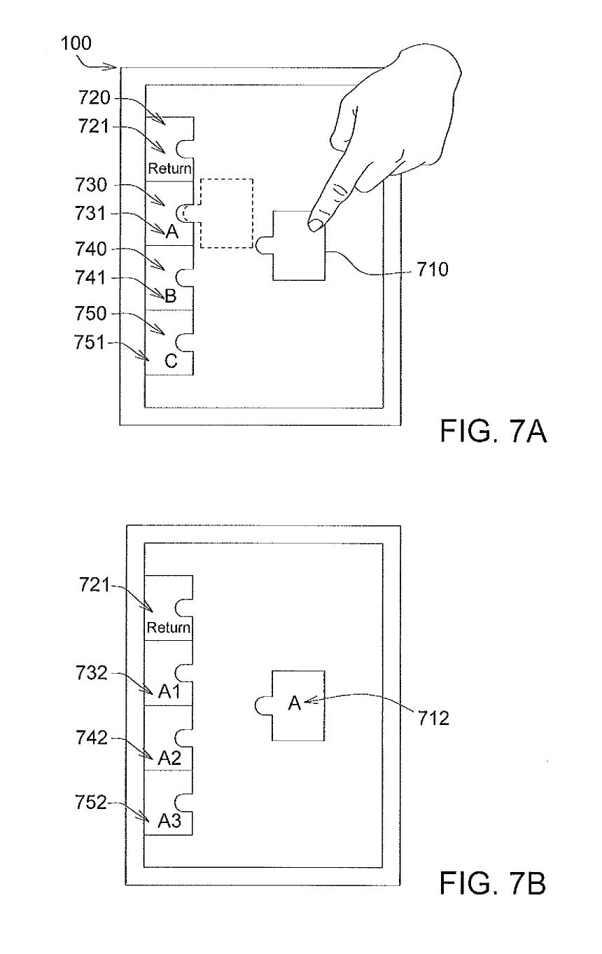

FIGS. 7A and 7B are schematic diagrams each showing an example of a graphical user interface of an electronic device according to an embodiment of the disclosure. In this example, the graphical user interface includes a movable object 710 and a number of indication objects 720, 730, 740, and 750. The indication objects 720, 730, 740, and 750 can be, for example but not limitedly, arranged on a same side of the movable object 710. The movable object 710 and each of the indication objects 720, 730, 740, and 750 have matched appearances, such as puzzle-like appearances, where convex and concave parts can match with each other. The indication objects 720, 730, 740, and 750 have four respective symbols 721, 731, 741, and 751 for identifying four respective functions of the electronic device 100. When the movable object 710 is dragged to a region of the indication object 730, the electronic device 100 initiates a function A. As shown in FIG. 7B, the removable object 710 returns to its initial position and has a symbol 712 of “A” indicating that the function is initiated. As regards indication objects 720, 730, 740, and 750, the symbol 721 is still for identifying a return function, while other symbols 731, 741, 751 are changed into other symbols 732, 742, 752 for identifying some sub-functions of the function A. As such, the electronic device 100 can be used to realize a hierarchical menu for function switching. In other words, a graphical user interface in FIG. 7A can be a main menu, and a graphical user interface in FIG. 7B can be a sub-menu.

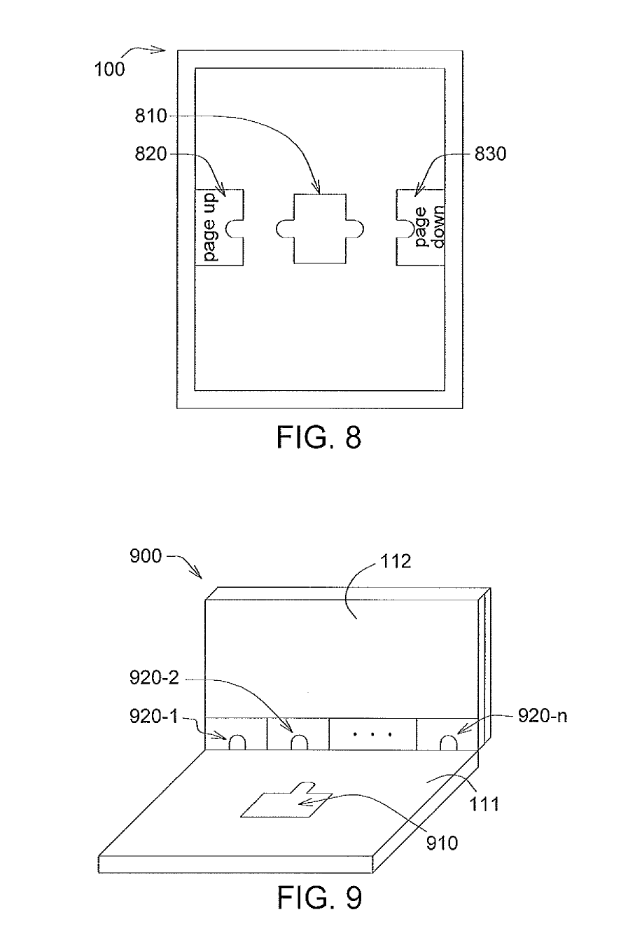

FIG. 8 is a schematic diagram showing another example of a graphical user interface of an electronic device according to an embodiment of the disclosure. In this example, the electronic device 100 is for example executing an application for reading or editing text or picture files. The graphical user interface includes a movable object 810 and two indication objects 820 and 830. The indication objects 820 and 830 have symbols of “page up” and “page down”. When the movable object 810 is dragged to a region of the indication object 820, the electronic device 100 will initiate a function of scrolling up in document or displaying a previous page; when the movable object 810 is dragged to a region of the indication object 830, the electronic device 100 will initiate a function of scrolling down in document or displaying a next page.

FIG. 9 is a schematic diagram showing another example of a graphical user interface of an electronic device according to an embodiment of the disclosure, wherein the electronic device includes two display panels and two touch panels. In this example, a graphical user interface of the electronic device 900 includes a removable object 910 and a number of indication objects 920-1˜920-n. The removable object 910 is displayed on a display panel 111, while the indication objects 920-1˜920-n are displayed on another display panel 112. Similar operation can be derived from aforementioned description and without repetition for the sake of brevity. As such, more indication objects can be displayed, and more functions can be provided for user's selection, thereby realizing an electronic device having diversified operation and increased convenience.

The electronic device provided in aforementioned description is exemplified as one capable of initiating a function such as a voice-phone call function, a video-phone call function, a page up function, or a page down function. The functions of the electronic device can be determined by executable applications of the electronic device, or services thereof. In other embodiments, the electronic device is capable of initiating other functions such as a message edition function, an edition function for a write pad, or an input function for hand writing. However, this disclosure is not limited thereto. Where there are cases in which a drag displacement on a touch panel is detected to determine whether the movable object is dragged to a region of the indication object, they are regarded as feasible and practicable embodiments of the disclosure.

According to the electronic device and the control method disclosed in the aforementioned exemplary examples, there is provided a graphical user interface which uses two graphical objects to suggest a way of interaction between users and the electronic device. When a region of a graphical object is touched, a drag displacement on the touch panel is detected. When the drag displacement reaches a predetermined displacement, a corresponding function of another graphical object is initiated. Therefore, the provided graphical user interface is convenient and human-friendly, and increases not only the convenience of operating the electronic device but also user experience.

It will be appreciated by those skilled in the art that changes could be made to the disclosed examples described above without departing from the broad inventive concept thereof. It is understood, therefore, that the disclosed examples are not limited to the particular examples disclosed, but is intended to cover modifications within the spirit and scope of the disclosed examples as defined by the claims that follow.

What is claimed is:

1. An electronic device, comprising:
a display panel for displaying a movable object and an indication object;
a touch panel covered on the display panel, wherein the movable object is displayed on a first display region of the display panel which corresponds to a first predetermined region of the touch panel, and the indication object is displayed on a second display region of the display panel which corresponds to a second predefined region of the touch panel;
a processor module for detecting, when the first predefined region is touched, whether a drag displacement on the touch panel reaches a predefined displacement, so as to determine whether the movable object is dragged to the second predefined region, the processor module further for initiating, when the drag displacement is detected as reaching the predefined displacement, a corresponding function of the indication object.

2. The electronic device according to claim 1, wherein the movable object has a symbol for identifying the corresponding function of the indication object, and the processor module is further for providing a change in appearance of the symbol of the movable object when the corresponding function of the indication object is initiated.

3. The electronic device according to claim 1, wherein the change in appearance of the symbol comprises a change in at least one of a color, a brightness level, a size, and a clarity level of the symbol.

4. The electronic device according to claim 1, wherein the processor module is further for changing a display size of the movable object according to the drag displacement.

5. The electronic device according to claim 1, wherein the indication object has a symbol for identifying the corresponding function of the indication object, and the processor module is further for changing the symbol of the indication object into another symbol for identifying another corresponding function of the indication object.

6. The electronic device according to claim 5, wherein the another corresponding function of the indication object is a sub-function of the identified function of the symbol prior to the switching.

7. The electronic device according to claim 1, wherein the indication object and the movable object have matched appearances.

8. The electronic device according to claim 1, wherein the drag displacement is a distance between an initial touch position and a terminal touch position of the touch panel.

9. The electronic device according to claim 1, wherein the predetermined displacement is a distance between the first predetermined region and the second predetermined region.

10. The electronic device according to claim 1, wherein when the drag displacement is determined as not reaching the predefined displacement, the processor module returns the movable object to the first predetermined region.

11. A control method for an electronic device, comprising:
displaying a movable object and an indication object on a display panel, the movable object being displayed on a first display region of the display panel which corresponds to a first predetermined region of a touch panel covered on the display panel, the indication object being displayed on a second display region of the display panel which corresponds to a second predefined region of the touch panel;
detecting, when the first predefined region is touched, whether a drag displacement on the touch panel reaches a predefined displacement, so as to determine whether the movable object is dragged to the second predefined region; and
initiating, when the drag displacement is detected as reaching the predefined displacement, a corresponding function of the indication object.

12. The control method according to claim 11, wherein the movable object has a symbol for identifying the corresponding function of the indication object, and the method further comprises:
providing, when the corresponding function of the indication object is initiated, a change in appearance of the symbol of the movable object.

13. The control method according to claim 11, wherein the change in appearance of the symbol comprises a change in at least one of a color, a brightness level, a size, and a clarity level of the symbol

14. The control method according to claim 11, further comprising:
changing a display size of the movable object according to the drag displacement.

15. The control method according to claim 11, wherein the indication object has a symbol for identifying the corresponding function of the indication object, and the method further comprises:
changing the symbol of the indication object into another symbol for identifying another corresponding function of the indication object.

16. The control method according to claim 15, wherein the another corresponding function of the indication object is a sub-function of the identified function of the symbol prior to the switching.

17. The control method according to claim 11, wherein the indication object and the movable object have matched appearances.

18. The control method according to claim 11, wherein the drag displacement is a distance between an initial touch position and a terminal touch position of the touch panel.

19. The control method according to claim 11, wherein the predetermined displacement is a distance between the first predetermined region and the second predetermined region.

20. The control method according to claim 11, further comprising:
returning, when the drag displacement is determined as not reaching the predefined displacement, the movable object to the first predetermined region.
